(19) United States
(12) Patent Application Publication
(10) Pub. No.: US 2004/0073486 A1
(43) Pub. Date: Apr. 15, 2004

(54) Method and system for purchasing goods in lottery selectable bonus goods free

(76) Inventor: Hee-Young Kim, Seoul (KR)

Correspondence Address: NOTARO AND MICHALOS, 100 DUTCH HILL ROAD, SUITE 110, ORANGEBURG, NY, 10962-2100, US

(21) Appl. No.: 10/468,705

(22) PCT Filed: Apr. 11, 2002
(86) PCT No.: PCT/KR02/00661

(30) Foreign Application Priority Data
Apr. 11, 2001 (KR) 2001-0019264

(51) Int. Cl. G06F 17/60

(52) U.S. Cl. 705/14

(57) ABSTRACT

The present invention relates to a method of and a system for purchasing goods in lottery, the method comprising the steps of connecting to a goods server to sell goods, searching goods, buying goods, providing a prize participation number to be able to participate in a prize event in plural prize places corresponding to a prize of goods for one client to purchase after finishing the purchase of goods, participating in the prize event by selecting one among the prize places, selecting winners of prizes in lottery when the participants amount to the number of persons to be admitted or on the spot, and providing the corresponding prizes to the winners.

### TECHNICAL FIELD

The present invention relates to a method of and a system for purchasing goods in lottery, wherein goods server to sell goods installs a plurality of prize-lottery event places which present various prizes and different exact probabilities of winning a first prize depending on a purchasing price of goods which a client has purchased, and wherein he can select lottery-prizes freely and participate in one of the prize-lottery event places in accordance with his intention. In detail, the present invention relates to a method of and a system for purchasing goods in lottery selectable bonus goods in free, wherein, in an on-line commercial transaction using an internet or a general commercial transaction, different lottery-prizes, different probabilities of winning first prize, target number of prizes, etc., depending on a purchasing price of goods for a client to have purchased are set up, and a client can subscribe for a prize or prizes which he wants or he can execute, and confirm, a prize winning or a lottery on the spot immediately.

### BACKGROUND ART

Recently, several kinds of lotteries or prizes are provided in the general commercial transaction(called as an off-line commercial transaction below) or the on-line commercial transaction using an internet.

However, the usual prizes or bonus goods is to present a subscriber right or a subscription form of prizes or bonus goods to clients to purchase goods above given amounts according to the so-called one-sided presentation of prizes or bonus goods by the sellers as a part of sales strategies for expanding operating profits or as a mark of appreciation in the circumstance for attracting customers, said clients filling in the subscription form and subscribing for the prizes or bonus goods. After a period of a prize-lottery event passed, winners are determined by a bundle lottery and prizes are given to the winners.

Therefore, the prize-lottery event is finished, for example, by holding up certain goods as a prize in an off-line commercial transaction, presenting a subscriber right or a subscription form of prizes or bonus goods to clients to purchase goods above given amounts with a determined period, selecting winners among the clients to have subscribed for the prizes with an announcement, and presenting the corresponding goods to the winners.

Such a prize-lottery event can improve a purchasing desire of clients as a transient event, but it is very difficult to keep such a desire continuously.

Furthermore, there are several problems from an aspect of purchasing goods, that, although the prize-lottery event is intended for unspecified clients, the ratio of winning numbers is not clearly or exactly determined, equity are not clear and any opportunity to select a prize or prizes is not given to the clients to participate in the prize-lottery event, such problems being sometimes exposed surrounding the prize-lottery.

In addition, it can be known that, in an on-line commercial transaction using an internet, a discount factor in the price of goods due to reduction in circulating steps of goods is applied directly to the price of goods, thereby causing a conflict phenomenon between the on-line commercial transaction and the off-line commercial transaction.

### DISCLOSURE OF INVENTION

Accordingly, the present invention is made in order to solve the above problems, and one object of the present invention is to provide a method of and a system for purchasing goods with good luck in prize-lottery event in which, in an on-line commercial transaction or an off-line commercial transaction using an internet, a prize or prizes corresponding to a constant ratio of operating profits due to sale of goods are presented to clients to purchase goods above given amounts through a lottery performed on the spot or later.

Further, it is another object of the present invention to provide a method of and a system for purchasing goods in lottery selectable bonus goods in free in which, in an on-line commercial transaction or an off-line commercial transaction using an internet, clients can purchase goods by connecting a goods server to store classified various goods, such a goods server delivers a prize-lottery participation number corresponding to a price of goods for clients to purchase after settlement of the price, and the clients can move to a plurality of prize-lottery event places arranged dependent on a purchasing price of goods and/or probabilities of winning first prize or prize contents in order to participate in the prize-lottery event after confirming them.

It is still another object of the present invention to provide a method of and a system for purchasing goods in lottery selectable bonus goods in free, wherein a prize or prizes corresponding to a constant ratio of operating profits due to sale of-goods can be continuously presented to clients, and opportunity to enable clients to participate in the prize-lottery event of high winning probability can be given to the clients, thereby maximizing a continuously attracting effect of customers.

It is still another object of the present invention to provide a method of and a system for purchasing goods in lottery selectable bonus goods in free, wherein prize names, winning probability of the first prize, the number of participants in the prize-lottery event, etc., are displayed on the goods-search screen in a manner in which a constant ratio of operating profits due to sale of goods can be continuously given back to clients in the configuration of lottery-prizes, thereby maximizing an expanding effect of customer attraction.

It is still another object of the present invention to provide a method of and a system or purchasing goods in lottery selectable bonus goods in free, wherein clients can select a prize or prizes in free in a plurality of prize-lottery event places arranged dependent on the winning probability of the first prize among preliminarily determined winning probabilities to be provided when clients purchase goods, and can obtain good fortune such as goods or cash of a higher price than a purchasing price of goods which a client has directly purchased, etc., when wining the first prize in lottery.

It is still another object of the present invention to provide a method of and a system for purchasing goods in lottery selectable bonus goods in free, wherein winning probabilities to be provided when clients purchase goods are preliminarily determined, and can obtain good fortune such as prescribed goods or cash although clients may not win the first prize in lottery, thereby maximizing customers' benefit.

To accomplish the object of this invention, a system for purchasing goods in lottery selectable bonus goods in free is provided in accordance with one embodiment of the present invention, which is characterized by comprising:

a plurality of clients to intend purchase of goods; and,

a goods server which stores various goods classified so as to conduct a search easily and sells goods, which installs a plurality of prize-lottery event places in correspondence with prices of goods for clients to purchase, which enables the clients to select lottery-prizes freely and participate in the prize-lottery, which selects the winners of the prizes in lottery when clients to have participated in the prize-lottery event amount to the number of persons to be admitted, and which presents the corresponding prizes to the winners.

A system for purchasing goods in lottery selectable bonus goods in free is provided in accordance with another embodiment of the invention, which is characterized by comprising:

a plurality of clients to intend purchase of goods; and,

a goods server which stores various goods classified so as to conduct a search easily and sells goods, which installs a plurality of prize-lottery event places in correspondence with prices of goods for clients to purchase, which enables the clients to select lottery-prizes freely and participate in the prize-lottery, in which the clients confirm the winners of the prizes in lottery on the spot, and which presents the corresponding prizes to the winners.

Preferably, said plurality of prize-lottery event places classified by purchase-price ranges comprise a plurality of prize-lottery event places which present as a prize different goods according to different probabilities of winning a first prize, and/or goods of a higher price is provided as prizes as low as probabilities of winning a first prize is in the prize-lottery event. Moreover, a gift is preferably provided to each client who is not the winner in lottery, but participates in the event.

It is also desirable that the prizes can be provided instead of goods in such forms as cash, goods corresponding to cash, merchandise coupons corresponding to cash, goods exchange tickets, merchandise coupons by which service can be provided such as travel coupons, rights to be able to do predetermined behavior such as a right to be able to insert his own works in a magazine, etc.

A method of purchasing goods in lottery selectable bonus goods in free in accordance with the invention, is characterized by comprising the steps of:

connecting to a goods server to sell goods;

searching goods provided in the goods server, and buying the goods;

providing a prize-lottery participation number to be able to participate in a prize-lottery event in a plurality of prize-lottery event places corresponding to a price of goods for one client to purchase after finishing the purchase of the goods;

participating in the prize-lottery event by selecting one among the prize-lottery event places and inputting the prize-lottery participation number;

selecting winners of prizes in lottery when clients to have participated in the prize-lottery event amount to the number of persons to be admitted in one selected prize-lottery event place; and,

providing the corresponding prizes to the winners when the winners of the prizes are decided in lottery.

Another method of purchasing goods in lottery selectable bonus goods in free in accordance with the invention, is characterized by comprising the steps of:

connecting to a goods server to sell goods;

searching goods provided in the goods server, and buying the goods;

providing a prize-lottery participation number to be able to participate in a prize-lottery event in a plurality of prize-lottery event places corresponding to a price of goods for one client to purchase after finishing the purchase of the goods;

participating in the prize-lottery event by selecting one among the prize-lottery event places and inputting the prize-lottery participation number;

confirming a result of lottery among the prizes on the spot; and,

providing a corresponding prize when the prize-lottery participation number is decided as winner in lottery.

The clients can confirm the result of lottery on the spot or can be informed later. Also, the prize-lottery event places comprise a plurality of prize-lottery event places arranged dependent on a purchasing price of goods and/or probabilities of winning first prize. Still futhermore, clients can participate in one of the prize-lottery event places corresponding to their purchase-prices, or can participate in the prize-lottery event places corresponding to lower prices than their purchase-prices several times within the scope of their purchase-prices.

A method of purchasing goods in lottery selectable bonus goods in free in accordance with another embodiment of the present invention, is characterized by comprising the steps of:

connecting to a goods server to sell goods;

searching goods provided in the goods server, and buying the goods;

providing a prize-lottery participation number to be able to participate in a prize-lottery event in a plurality of prize-lottery event places corresponding to a price of goods for one client to purchase after finishing the purchase of the goods;

participating in the prize-lottery event by selecting one among the prize-lottery event places and inputting the prize-lottery participation number;

selecting winners of prizes in lottery when clients to have participated in the prize-lottery event amount to the number of persons to be admitted in one selected prize-lottery event place, or deciding whether to win a prize on the spot; and,

providing the corresponding prizes to the winners when the winners of the prizes are decided in lottery or on the spot.

Said purchase can be preferably performed in an on-line commercial transaction, or can be performed in a TV home shopping, a department store, etc.

### BRIEF DESCRIPTION OF DRAWINGS

FIG. 1 shows a block diagram illustrating the schematic construction of a system for realizing a method of purchasing goods in lottery selectable bonus goods in free according to the invention.

FIGS. 2 to 13 illustrate in order display screens represented to clients for realizing a method of purchasing goods in lottery selectable bonus goods in free.

FIGS. 14 to 16 illustrate display screens represented to clients for a method enabling immediate confirmation of the result of prizes among methods of purchasing goods in lottery selectable bonus goods in free.

FIG. 17 shows a flow chart illustrating the concrete procedures for a method of purchasing goods in lottery selectable bonus goods in free according to one embodiment of the present invention.

FIG. 18 shows a flow chart illustrating the concrete procedures for a method of purchasing goods in lottery selectable bonus goods in free according to another embodiment of the present invention.

### BEST MODE FOR CARRYING OUT THE INVENTION

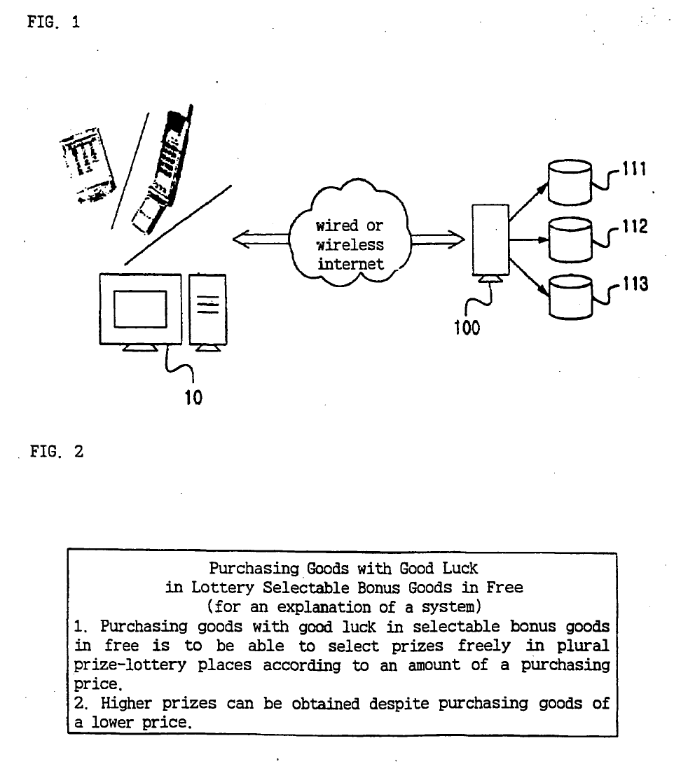

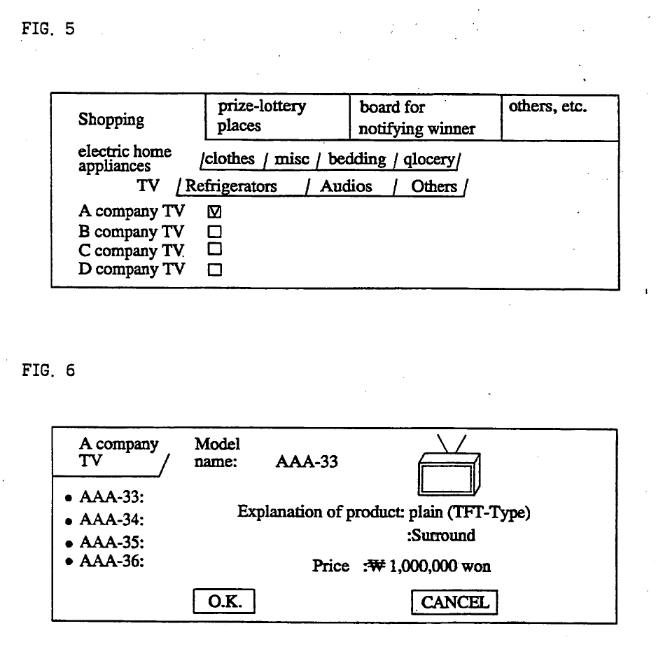

Now, preferred embodiments of the present invention will be described in detail with reference to the accompanying drawings of FIGS. 1 to 18.

FIG. 1 shows a block diagram illustrating the schematic construction of a system for realizing a method of purchasing goods in lottery selectable bonus goods in free according to the invention.

The method of and the system for purchasing goods in lottery selectable bonus goods in free according to the invention can be applied to both of an on-line, and an off-line, commercial transaction.

For example, in the on-line commercial transaction, goods sell in the same normal consumer prices as in the off-line commercial transaction, but it is an elementary principle that a constant ratio of discount factor due to reduction in circulating steps of goods and operating profits due to sale of goods is returned clients to purchase goods as various types of prizes.

In the present invention, the prizes are provided in such forms as cash, goods corresponding to cash, merchandise coupons corresponding to cash, goods exchange tickets, merchandise coupons by which service can be provided such as travel coupons, rights to be able to do predetermined behavior such as a right to be able to insert his own works in a magazine, etc., being designated as goods simply provided as the prizes for an easy explanation.

In FIG. 1, a reference numeral “10” as representing a client or clients, is a user of an internet mobile telephone, a personal digital assistant (PDA) or a personal computer. Also, a reference numeral “100” is a goods server for realizing an on-line purchase of goods using an wired or wireless internet in accordance with the present invention. Here, the goods server 100 includes plural databases such as a goods database 111 storing prices and specifications of goods, etc., so as for the clients to be able to easily search, a database 112 for plural prize-lottery places to store contents of the prizes, winning probability, lottery data, etc., when purchasing goods with good luck, a database 113 of a lottery method to store various lottery games, puzzle quiz methods, etc. In FIG. 1, the system for purchasing goods in lottery selectable bonus goods in free is described in some detail by way of illustration and example, but it should be understood that, without any limitation to the practice of the present invention, a method of purchasing goods with good luck according to the present invention can be applied to prizes provided in an off-line commercial transaction such as a large-sized discount store, a department store, a TV home shopping, etc., if necessary.

One preferred embodiment of the present invention will be described in detail with reference to the accompanying drawings of FIGS. 2 to 13 and FIG. 3.

FIGS. 2 to 13 and FIG. 3 illustrate in order the procedures for one method of purchasing goods in lottery selectable bonus goods in free according to the embodiment of the present invention.

One display screen shown in FIG. 2 is a page for introducing the method of and the system for purchasing goods in lottery selectable bonus goods in free since the method of purchasing goods with good luck according to the present invention is not well-known to the common clients 10. Since this display screen is temporarily used, the practice of the present invention can be publicized or explained in detail using a JAVA Appelet for an internet.

In FIG. 3, the goods server 100 registers various goods classified so as for the clients to conduct a search easily, and includes a plurality of prize-lottery places in various forms and notification boards for winners of the prizes, etc., while performing on-line commercial transactions. In FIG. 3, there can be included banner advertisements for informing drawing methods of lots, drawing date of lots, etc., or for advertizing goods, notification boards for notifying useful informations for selecting goods, experiences for the clients to use goods, etc., or separate methods necessary for the community, if necessary. The prize-lottery places are explained later in detail with reference to FIGS. 9 to 12.

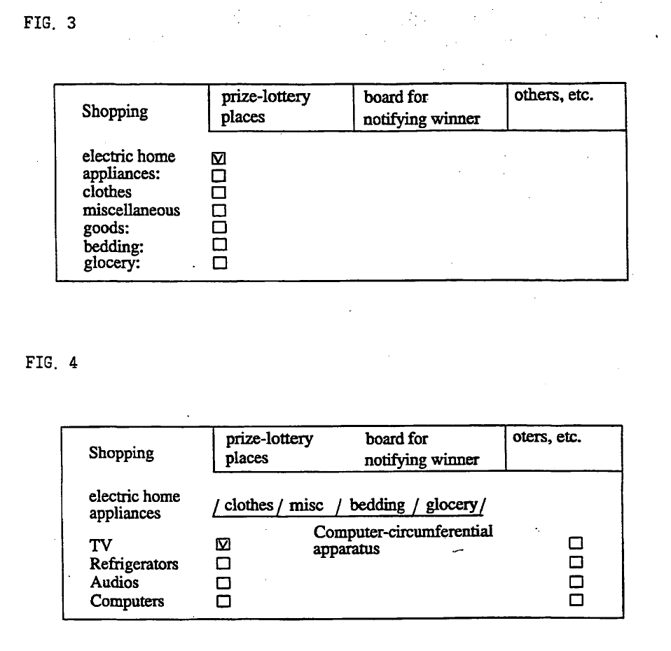

Referring again to FIG. 3 when the clients 10 open the shopping page for purchasing goods, the goods server 100 stores various goods classified such as general electric home appliances, clothes, miscellaneous goods, bedding, grocery, etc., according to one classification, but, without any limitation of such a classification method, can store goods so as to be able to conduct a search easily and compare with different goods easily. For example, as shown in FIG. 4, general electric home appliances may comprise classified TV, refrigerators, audios, computers, etc. Also, for example, in case the client 10 is purchasing a TV, the goods server 100 can store TVs on the market classified by makers, screen sizes, prices, etc., and can display them according to a request of the clients 10.

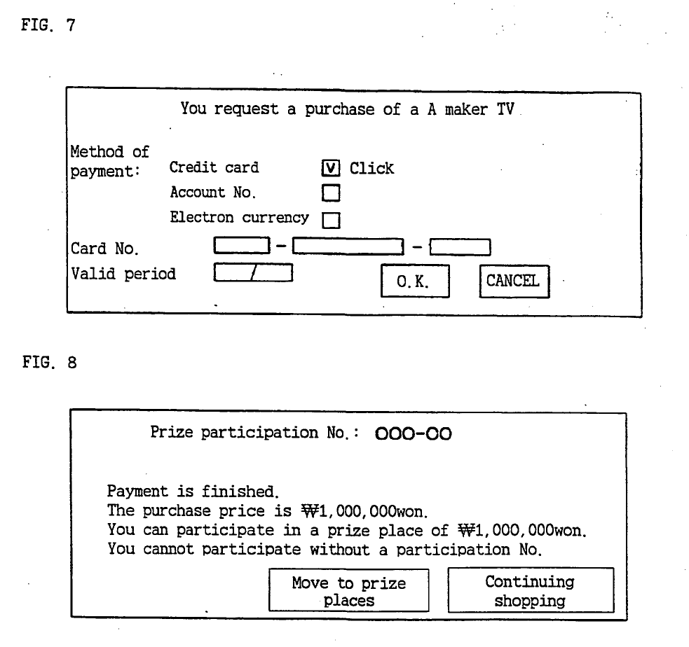

FIG. 6 is a screen showing photo informations of goods, detailed informations, prices, etc., according to models of a selected goods so as to decide whether to purchase. If the clients 10 request purchase, the screen moves to FIG. 7 showing payment methods, etc., and when payment is finished, a prize-lottery participation number for prizes corresponding to a price of goods for clients to purchase is provided. As in FIG. 7, in case the clients 10 request A company's TV of W1,000,000won, a prize-lottery participation number for prizes corresponding to W1,000,000won is provided.

In a system for purchasing goods with good luck in lottery selectable bonus goods in free according to the present invention, the prize-lottery participation number for prizes corresponding to a price of goods for clients to purchase is provided and, using the prize-lottery participation number, the clients 10 can select various prizes of the prize-lottery event places stored in the prize-place database 112 including prizes.

Here, as shown in FIG. 9, the prize-place database 112 comprises prizes corresponding to the purchasing prices. And, several prize places are arranged having different prize contents according to the prize-lottery participation number even in the same price. For example, the client 10 can participate in a prize place of W1,000,000won among prize places shown in FIG. 9 because he purchases goods of W1,000,000won through FIGS. 7 to 8 and receives a prize-lottery participation number corresponding to the purchase price at the time of finishing payment in the goods server 100. In this case, goods provided as prizes in the prize place of W1,000,000won may be more expensive than those provided as prizes in the prize place of W100,000won. Here, the clients 10 can select one times in the prize place of W1,000,000won, but can select ten times in the prize place of W100,000won of the lower price with the same prize-lottery participation number.

Meanwhile, a plurality of prize places having different probabilities of winning a first prize are arranged even in a prize place of the same price range. Of course, goods to be provided in the prize place, where probabilities of winning a first prize is lower, will be goods of a higher price than those to be provided in the prize place, where probabilities of winning a first prize is higher.

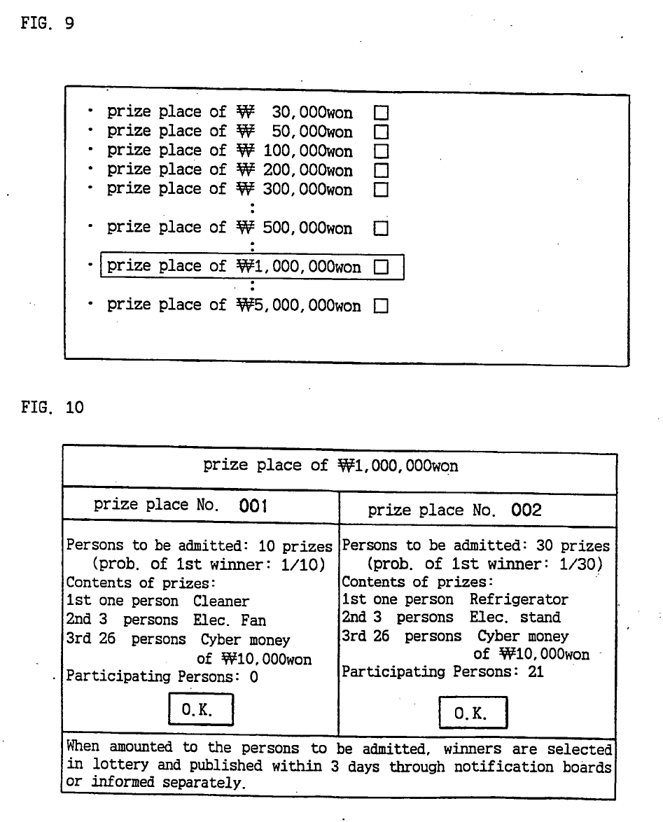

For example, as shown in FIG. 10, the prize places of W1,000,000won may comprise plural prize places of 1/10, 1/30, 1/50, 1/00 etc., in probabilities of winning first prize. As low as the probabilities of winning a first prize are, the bigger the scale of goods to be provided becomes. Accordingly, although the clients 10 may buy goods of a low price, he can participate in the prize place to win a prize of a high price selectively.

In each prize place, probabilities of winning a first prize will be decided depending on the number of persons to be admitted. For example, if the probabilities of winning a first prize is 1/10, the number of persons to be admitted will be ten. When the participants amount to the number of persons to be admitted, a drawing of lots is performed as for the clients 10 to participate in the prize-lottery event, deciding one first winner, two sencond winners and seven third winners. Here, the probabilities of winning a first prize are designated depending on the selection standard of the first winner among the number of persons to be admitted or assembled as a target. The numbers of a first, second or third winners can be changed properly by the prize contents.

Also, each prize place discloses the numbers of the persons to participate in the present prize-lottery event, electron mail address, etc. When the clients 10 participate in the prize event and fill in the electron mail address, a result of lottery can be informed to corresponding winners or the clients 10 immediately or by other methods, or can be confirmed on the notification boards of winners.

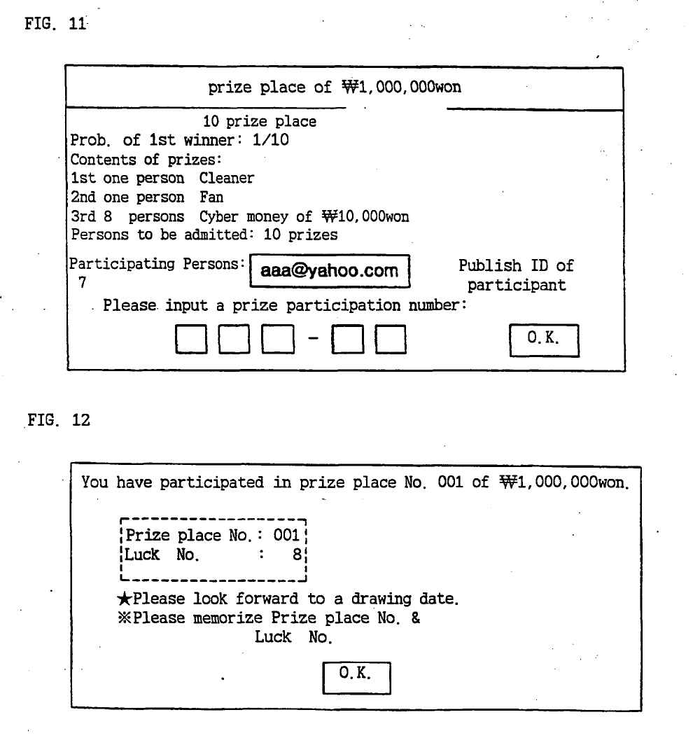

FIG. 11 shows one prize places of 1/10 in the probabilities of winning a first prize among the prize places of W1,000,000won or above for example. The clients 10 to purchase goods of W1,000,000won or above and finish payment can participate in the prize-lottery event by filling in the provided prize-lottery participation number.

In FIG. 12, when the clients 10 participate in the prize-lottery event by inputting the prize-lottery participation number, a prize place number and a luck number are displayed. Here, the displayed prize place number and luck number can be used for confirming the result of lottery on the notification boards of winners in case the clients 10 are not informed of the result of lottery due to an error of the electron mail address, etc.

Here, informations such as the electron mail address, a dilivery place, etc., can be provided or inputted in separate ways at or before participating the prize-lottery event.

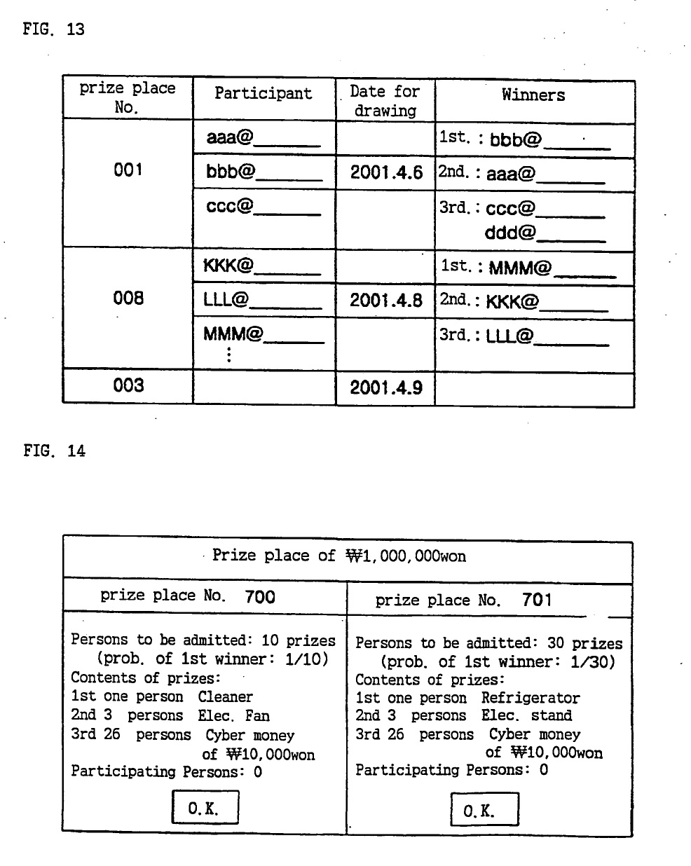

FIG. 13 shows one example of the notification boards of winners, which comprises a prize event number, electron mail addresses of the participants, date of drawing lots, winners, etc., and can include a search function for facilitating search.

Another embodiment of the present invention will be described in detail with reference to the accompanying drawings of FIGS. 14 to 16, in which it is possible to select prizes freely and to confirm the result of lottery on the spot.

The procedures in which the clients 10 purchase goods and are given a prize-lottery participation number corresponding to the purchase price are similar to those aforementioned in FIGS. 2 to 8. When the clients 10 to receive the prize-lottery participation number wants to confirm the prize on the spot, he can participate in an on-the-spot prize place shown in FIG. 14. A winning probability and goods can be similar to, or different from, those in FIG. 10.

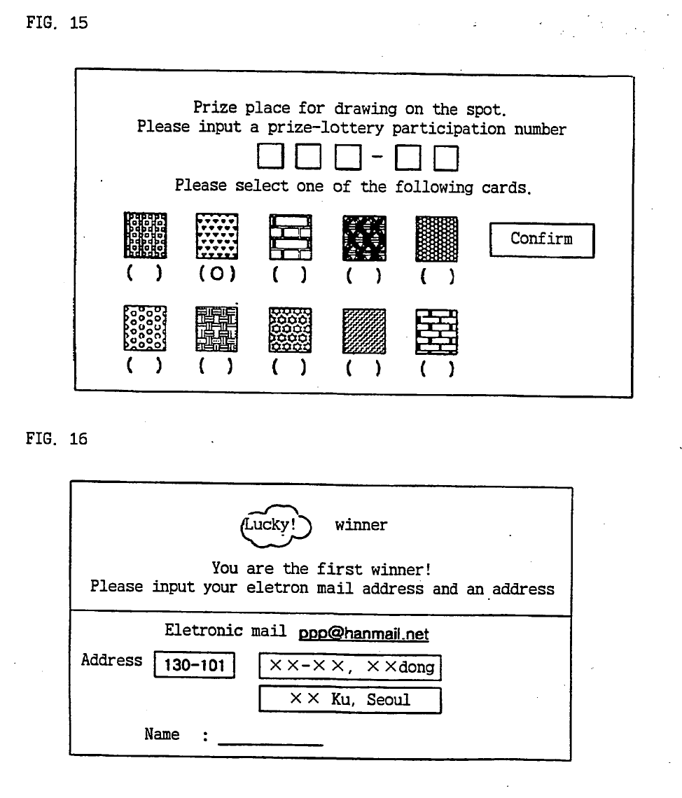

In FIG. 15, the clients 10 input the prize-lottery participation number and select one among cards of the number corresponding to the probabilities of winning a first prize, thereby being capable of confirming the result of lottery on the spot as shown in FIG. 16.

The above-described prizes in the system for purchasing goods in lottery selectable bonus goods in free are taken as examples simply, but the present invention is not limited thereto. For example, the prizes can be provided for publicizing novel products, or cyber money, cash, rights to be able to do a certain thing, etc.

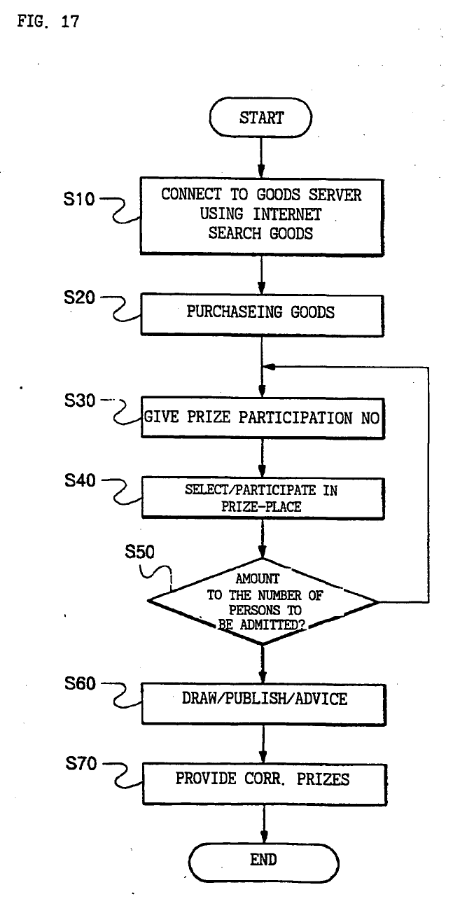

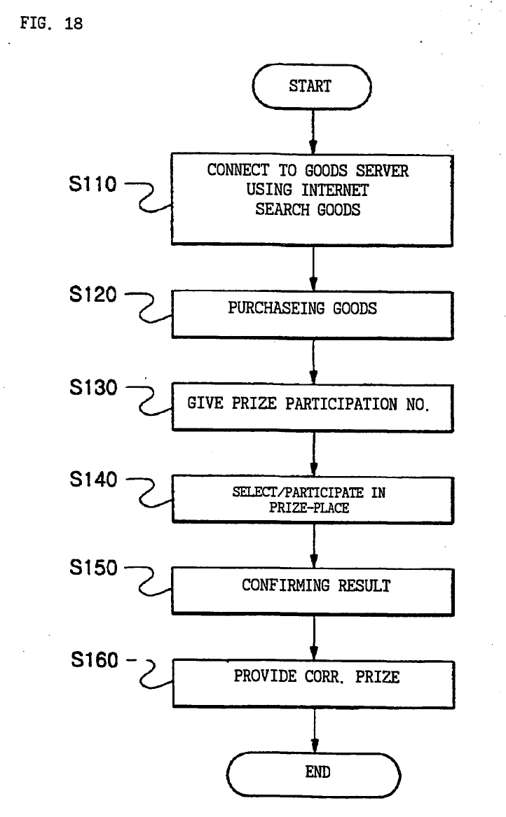

The above-mentioned method of purchasing goods in lottery selectable bonus goods in free with good luck will be explained in order referring to FIGS. 17 and 18.

FIG. 17 is a flow chart illustrating the concrete procedures for a method of purchasing goods in lottery selectable bonus goods in free according to one embodiment of the present invention.

In step S10, the clients 10 are connected to a goods server 100 using an internet, and search goods. The goods server 100 includes a goods database 111 to store various goods classified so as for the clients to be able to easily search.

The clients 10 purchase goods(step S20), and are provided with a prize-lottery participation number when payment is finished(step S30). Here, the prize-lottery participation number is one corresponding to the price of goods for the clients 10 to purchase in the goods server 100. The clients 10 to be given the prize-lottery participation number can participate in one of plural prize places by inputting his prize-lottery participation number(step S40).

Here, the prize places are arranged variously according to the amount corresponding to a purchasing price of goods. Also, plural prize places are arranged which have different probabilities of winning first prize in the prize place of the same purchase price range. In each of such prize places where the numbers of persons to be admitted or assembled are given respectively, it is decided whether to amount to the number of persons to be admitted(step S50), and if not, the step S30 is performed and assembled continuously until participants amount to the number of persons to be admitted. In case the participants amount to the number of persons to be admitted, selecting step for winners of prizes in lottery is performed. Thus, winners are selected in lottery and advised of the fact(step S60), and then the winners are provided with the corresponding prizes(step S70).

A method of purchasing goods in lottery selectable bonus goods in free in which the clients 10 can participate in the prize event and confirm a result of lottery on the spot will be explained hereinafter with reference to FIG. 18.

In the method of purchasing goods in lottery selectable bonus goods in free described above, plural prize places are arranged correspoding to prices of goods for the clients 10 to purchase. At the same time, such prize places comprise plural prize places for confirming the result of lottery on the spot.

In step S110, the clients 10 are connected to a goods server 100 using an internet, and search goods, similarly to the abovementioned method. Also, the goods server 100 includes a goods database 111 to store various goods classified so as for the clients to be able to easily search.

The clients 10 purchase goods(step S120), and are provided with a prize-lottery participation number when payment is finished(step S130). Here, the prize-lottery participation number is one corresponding to the price of goods for the clients 10 to purchase in the goods server 100. The clients 10 to be given the prize-lottery participation number can participate in one of plural prize places by inputting his prize-lottery participation number(step S140).

In step S150, when the clients 10 select one among the cards as shown in FIG. 15, he can confirm a result of lottery on the spot. In this embodiment, the goods for the clients 10 to have purchased and the won prize can be delivered together, thereby reducing the delivery cost at the side of the goods server 100. Meanwhile, it is advantageous for the clients 10 to receive the purchase goods and the prize at the same time.

In the method of purchasing goods in lottery selectable bonus goods in free in FIGS. 17 and 18, the methods of lottery and confirming the result of lottery are explained separately for a simple explanation, which can be actually used at the same time.

According to the method of and a system for purchasing goods in lottery selectable bonus goods in free in accordance with the embodiments of the present invention described above, goods are selled at the market price in an on-line commercial transaction or an off-line commercial transaction using an internet, and a constant ratio of operating profits due to sale of goods are presented to clients to purchase goods as a prize or prizes corresponding to the purchase price through a lottery, thereby being capable of resulting in substantial effect on attracting customers into the internet shopping.

According to the method of and the system for purchasing goods in lottery selectable bonus goods in free in accordance with another embodiment of the present invention, the clients can participate in the prize places with selecting a prize or prizes in free in a plurality of prize places besides goods for the clients to purchase in an on-line commercial transaction or an off-line commercial transaction, and can have an opportunity to receive goods or cash of a higher price than a purchasing price of the purchased goods when wining the first prize in lottery, while manufacturers can realize market networks to sell products stably. Also, the manufacturers of goods should produce goods for selling and for prizes continuously, thereby enabling the promoting of consumption of goods.

According to the method of and the system for purchasing goods in lottery selectable bonus goods in free in accordance with still another embodiment of the present invention, the clients can select, and participate in, one of the prize places which display the probabilities of winning a first prize and the number of persons to be admitted, thereby being capable of having an opportunity to receive his desired prizes and maximizing an effect of customer attraction. Also, in the method of returning a constant ratio of operating profits due to sale of goods, the effect can be obtained which maximizes an expanding effect of customer attraction by displaying informations of goods, winning probability of prizes, the number to have been sold, etc., in the search screen.

Here, the inventive system for purchasing goods in lottery selectable bonus goods in free is to return a constant ratio of operating profits due to sale of goods to the clients who have purchased goods through the method of and the system for purchasing goods in lottery selectable bonus goods in free, thereby being capable of attracting customers and creating a new profitable model by an advertisement due to such attraction of the customers, etc.

According to the method of and the system for purchasing goods in lottery selectable bonus goods in free in accordance with still another embodiment of the present invention, the manufacturers can produce goods without any sacrifice of margin such as a severe discount of goods, etc., while the clients can be attracted to purchase another goods by presenting as prizes a constant ratio of operating profits due to sale of goods through the method of and the system for purchasing goods in lottery selectable bonus goods in free, enabling the promotion of consumption and the prevention of conflict between the on-line commercial transaction and the off-line commercial transaction, and resulting in establishing order in circulation of goods

According to the method of and the system for purchasing goods in lottery selectable bonus goods in free in accordance with still another embodiment of the present invention, the manufacturers can stably sell the products at a stable price and an effective market route can be provided to small and medium-sized enterprises having superior technology

Although the foregoing invention has been described in some detail by way of illustration and example for purposes of clarity of understanding, it is readily apparent to those of ordinary skill in the art in light of the teachings of this invention that certain changes and modifications including a change between plural elements and a singular element may be made thereto without departing from the spirit or scope of the appended claims.

1. A system for purchasing goods in lottery selectable bonus goods in free, said system comprising:
a plurality of clients to intend purchase of goods; and,
a goods server which stores various goods classified so as to conduct a search easily and sells goods, which installs a plurality of prize-lottery event places in correspondence with prices of goods for clients to purchase, which enables the clients to select lottery-prizes freely and participate in the prize-lottery, which selects the winners of the prizes in lottery when clients to have participated in the prize-lottery event amount to the number of persons to be admitted, and which presents the corresponding prizes to the winners.

2. A system for purchasing goods in lottery selectable bonus goods in free, said system comprising:
a plurality of clients to intend purchase of goods; and,
a goods server which stores various goods classified so as to conduct a search easily and sells goods, which installs a plurality of prize-lottery event places in correspondence with prices of goods for clients to purchase, which enables the clients to select lottery-prizes freely and participate in the prize-lottery, in which the clients confirm the winners of the prizes in lottery on the spot, and which presents the corresponding prizes to the winners.

3. A system for purchasing goods in lottery selectable bonus goods in free according to claim 1 or claim 2, said system being characterized in that said plurality of prize-lottery event places comprise a plurality of prize-lottery event places classified by purchase-price ranges of the clients according to prices of goods for clients to purchase.

4. A system for purchasing goods in lottery selectable bonus goods in free according to claim 3, said system being characterized in that said plurality of prize-lottery event places classified by purchase-price ranges comprise a plurality of prize-lottery event places which present as a prize different goods according to different probabilities of winning a first prize.

5. A system for purchasing goods in lottery selectable bonus goods in free according to claim 1 or claim 2, said system being characterized in that a gift is provided to each client who is not the winner in lottery, but participates in the event.

6. A system for purchasing goods in lottery selectable bonus goods in free according to claim 1 or claim 2, said system being characterized in that the clients can participate several times in prize-lottery events besides prize-lottery event places corresponding to their purchase-prices within the scope of their purchase-prices using prize-lottery participation numbers provided to the clients after purchasing goods.

7. A system for purchasing goods in lottery selectable bonus goods in free according to claim 1 or claim 2, said system being characterized in that the prizes can be provided by cash instead of goods.

8. A system for purchasing goods in lottery selectable bonus goods in free according to claim 1 or claim 2, said system being characterized in that the prizes can be provided by merchandise coupons corresponding to cash instead of goods.

9. A system for purchasing goods in lottery selectable bonus goods in free according to claim 1 or claim 2, said system being characterized in that the prizes can be provided by merchandise coupons instead of goods, by which goods and/or service can be provided.

10. A system for purchasing goods in lottery selectable bonus goods in free according to claim 1 or claim 2, said system being characterized in that the prizes is right to be able to do predetermined behavior.

11. A method of purchasing goods in lottery selectable bonus goods in free, said method comprising the steps of:
connecting to a goods server to sell goods;
searching goods provided in the goods server, and buying the goods;
providing a prize-lottery participation number to be able to participate in a prize-lottery event in a plurality of prize-lottery event places corresponding to a price of goods for one client to purchase after finishing the purchase of the goods;
participating in the prize-lottery event by selecting one among the prize-lottery event places and inputting the prize-lottery participation number;
selecting winners of prizes in lottery when clients to have participated in the prize-lottery event amount to the number of persons to be admitted in one selected prize-lottery event place; and,
providing the corresponding prizes to the winners when the winners of the prizes are decided in lottery.

12. A method of purchasing goods in lottery selectable bonus goods in free, said method comprising the steps of:
connecting to a goods server to sell goods;
searching goods provided in the goods server, and buying the goods;
providing a prize-lottery participation number to be able to participate in a prize-lottery event in a plurality of prize-lottery event places corresponding to a price of goods for one client to purchase after finishing the purchase of the goods;
participating in the prize-lottery event by selecting one among the prize-lottery event places and inputting the prize-lottery participation number;
confirming a result of lottery among the prizes on the spot; and,
providing a corresponding prize when the prize-lottery participation number is decided as winner in lottery.

13. A method of purchasing goods in lottery selectable bonus goods in free according to claim 11 or claim 12, said method being characterized in that the prize-lottery event places comprise a plurality of prize-lottery event places arranged dependent on a purchasing price of goods and/or probabilities of winning first prize.

14. A method of purchasing goods in lottery selectable bonus goods in free according to claim 11 or claim 12, said method being characterized in that clients can participate in one of the prize-lottery event places corresponding to their purchase-prices.

15. A method of purchasing goods in lottery selectable bonus goods in free according to claim 11 or claim 12, said method being characterized in that clients can participate in the prize-lottery event places corresponding to lower prices than their purchase-prices several times within the scope of their purchase-prices besides prize-lottery event places corresponding to their purchase-prices.

16. A method of purchasing goods in lottery selectable bonus goods in free, said method comprising the steps of:
connecting to a goods server to sell goods;
searching goods provided in the goods server, and buying the goods;
providing a prize-lottery participation number to be able to participate in a prize-lottery event in a plurality of prize-lottery event places corresponding to a price of goods for one client to purchase after finishing the purchase of the goods;
participating in the prize-lottery event by selecting one among the prize-lottery event places and inputting the prize-lottery participation number;
selecting winners of prizes in lottery when clients to have participated in the prize-lottery event amount to the number of persons to be admitted in one selected prize-lottery event place, or deciding whether to win a prize on the spot; and,
providing the corresponding prizes to the winners when the winners of the prizes are decided in lottery or on the spot.

17. A method of purchasing goods in lottery selectable bonus goods in free according to claim 16, said method being characterized in that said purchase is performed in an on-line commercial transaction.

18. A method of purchasing goods in lottery selectable bonus goods in free according to claim 16, said method being characterized in that said purchase is performed in a TV home shopping.

19. A method of purchasing goods in lottery selectable bonus goods in free according to claim 16, said method being characterized in that said purchase is performed in a department store.
